(19) United States
(12) Patent Application Publication
(10) Pub. No.: US 2009/0150515 A1
(43) Pub. Date: Jun. 11, 2009

(54) MULTI-INTERFACE STORAGE DEVICE

(75) Inventors: Rong-Hua Kung, Taipei Hsien (TW); Jin-Yuan Wang, Taipei Hsien (TW)

Correspondence Address: KIRTON AND MCCONKIE, 60 EAST SOUTH TEMPLE,, SUITE 1800, SALT LAKE CITY, UT, 84111, US

(73) Assignee: APACER TECHNOLOGY INC., Taipei Hsien (TW)

(21) Appl. No.: 12/062,796

(22) Filed: Apr. 4, 2008

(30) Foreign Application Priority Data
Dec. 6, 2007 (TW) 096146601

(51) Int. Cl. G06F 15/16

(52) U.S. Cl. 709/217

(57) ABSTRACT

A multi-interface storage device used in a computer under power off status is disclosed and adapted for transmitting data and communicating with an external electronic device remotely. The multi-interface storage device used in the computer under power off status comprises a transmission interface, an internet interface, a storage unit for storing data and a processing unit. The transmission interface is connected with an electronic device inside the computer, and the internet interface is connected with the external electronic device. The processing unit is connected with the storage unit, the internet interface and the transmission interface for communicating with the external electronic device through the internet interface to enable the external electronic device to store and process the data stored in the storage unit under the power off status of the computer.

### FIELD OF THE INVENTION

The present invention relates to a multi-interface storage device used in a computer under power off status, and more particularly to a multi-interface storage device used in a computer under power off status having an internet interface.

### BACKGROUND OF THE INVENTION

With increasing development of information system, data management and delivery has already being integrated into digital system, and the developments of all kinds of electronic devices are towards smaller and portable, such as the developments of laptop, Palm, personal digital assistant (PDA), portable media player (PMP), cellphone with camera, etc. These kinds of smaller electronic devices have advantages of portability, powerful calculating and processing abilities, and can connect to a computer host to transmit data to and from the storage device inside the computer, and provide users with more convenience.

However, the connection and data transmission between these portable electronic devices and computer host need to be processed under the condition of power on status of the computer host, and therefore, when the computer is shut down, these portable electronic devices cannot communicate with the computer host.

Especially when one is on business trip or goes out and finds out he needs the data stored in the computer host at home or in company, it results in that he can't get the data stored in the computer host because the computer host is turned off.

Some users may store their data on the virtual hard disks of internet remotely, while these virtual hard disks of internet provide services through a server on the net. However, if the server of supply terminal has problems or operates unstably, users may not get their data successfully, which causes troubles to users; moreover, the virtual hard disks of internet often need to be paid, and are easy to be cracked, so there exist disadvantages of high cost and low safety.

Currently, some computer systems have function of transmitting data remotely via internet connection so that users can turn on the computer host remotely, however, when users turn on the computer host through the internet connection remotely, it spends a while on waiting the computer host to be turned on and the storing and transmitting processes are complex, which cause inconvenience to the users.

In views of the above-described disadvantages resulted from the prior art, the applicant keeps on carving unflaggingly to develop a multi-interface storage device used in a computer under a power off status according to the present invention through wholehearted experience and research.

### SUMMARY OF THE INVENTION

It is an object of the present invention to provide a multi-interface storage device used in a computer under a power off status for transmitting data and communicating with an external electronic device remotely to solve the problems that the prior art needs to turn on the computer host remotely through the internet connection, the storing and transmitting processes are complex, and it wastes time and causes inconvenience to the users.

In accordance with a first aspect of the present invention, there is provided a multi-interface storage device used in a computer under a power off status for transmitting data and communicating with an external electronic device remotely. The multi-interface storage device comprises a transmission interface connected with an electronic device inside the computer, an internet interface connected with the external electronic device, a storage unit for storing data and a processing unit connected with the storage unit, the internet interface and the transmission interface for communicating with the external electronic device through the internet interface to enable the external electronic device to store and process the data stored in the storage unit under the power off status of the computer.

In an embodiment, the external electronic device is a laptop, a Palm, a PDA, a PMP or a cellphone with camera.

In an embodiment, the multi-interface storage device further comprises a power input unit for receiving a voltage signal for operation.

In an embodiment, the multi-interface storage device further comprises a memory unit for storing data needed for operation of said processing unit, wherein the memory unit is a ROM and/or a RAM.

In an embodiment, the multi-interface storage device further comprises a MAC connected with the internet interface and the processing unit for providing an IP address.

In an embodiment, the transmission interface is an IDE interface, an SCSI, an SATA interface, a USB or a PCI Express.

In an embodiment, the internet interface is a wired internet transmission interface being an IP interface.

In an embodiment, the internet interface is a wireless internet transmission interface being an IrDA interface, a Blue tooth interface, a GPRS interface, a GSM interface, a WLAN interface, a Wi-Max interface or a Wi-Fi interface.

In an embodiment, the storage unit is an SSD or an HDD.

In an embodiment, the processing unit is a micro-controller.

In accordance with a second aspect of the present invention, there is provided a multi-interface storage device used in a computer for transmitting data and communicating with an external electronic device remotely. The multi-interface storage device comprises a first transmission interface connected with an electronic device inside the computer, a second transmission interface connected with the electronic device inside the computer, an internet interface connected with the external electronic device, a storage unit for storing data, a first processing unit connected with the storage unit and the first transmission interface, a second processing unit connected with the second transmission interface and a switch connected with the first processing unit, the second processing unit and the internet interface, such that the first processing unit communicates with the external electronic device through the switch and the internet interface to enable the external electronic device to store and process the data stored in the storage unit under the power off status of the computer, and the second processing unit connects to an internet through the switch and the internet interface under a power on status of the computer.

In another embodiment, the multi-interface storage device further comprises a first MAC connected with the switch and the first processing unit, and a second MAC connected with the switch and the second processing unit, wherein the first MAC and the second MAC are for providing an IP address.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view of a multi-interface storage device according to a preferred embodiment of the present invention;

FIG. 2A is a schematic view illustrating the multi-interface storage device of FIG. 1 having a wired internet transmission interface;

FIG. 2B is a schematic view illustrating the multi-interface storage device of FIG. 1 having a wireless internet transmission interface;

FIG. 2C is a schematic view illustrating the multi-interface storage device of FIG. 1 having another wireless internet transmission interface;

FIG. 3 is a schematic view of a multi-interface storage device according to another preferred embodiment of the present invention;

FIG. 4A is a schematic view illustrating the multi-interface storage device of FIG. 3 having a wired internet transmission interface.

FIG. 4B is a schematic view illustrating the multi-interface storage device of FIG. 3 having a wireless internet transmission interface.

FIG. 4C is a schematic view illustrating the multi-interface storage device of FIG. 3 having another wireless internet transmission interface; and

FIG. 5 is a schematic view illustrating the multi-interface storage device of FIG. 3 having both a wired internet transmission interface and a wireless internet transmission interface.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

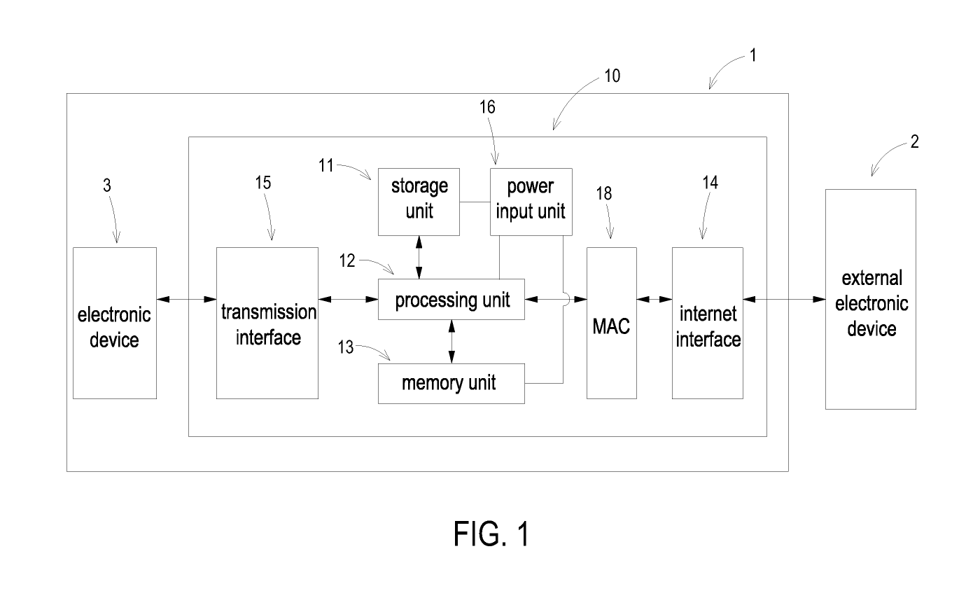

Please refer to FIG. 1, which is a schematic view of a multi-interface storage device according to a preferred embodiment of the present invention. As shown in FIG. 1, the multi-interface storage device 10 is disposed in a computer system 1, and includes a storage unit 11, a processing unit 12, a memory unit 13, an internet interface 14, a transmission interface 15, a power input unit 16 and a media access controller (MAC) 18. Wherein the storage unit 11 is for storing data, the transmission interface 15 connects with the electronic device 3 inside the computer system 1 for transmitting and communicating the data between the multi-interface storage device 10 and the computer system 1, the memory unit 13 could be but not limited to a ROM or a RAM for storing data needed for the operation of the processing unit 12, and the MAC 18 is for providing an internet protocol (IP) address to an external electronic device 2 to connect to the internet.

The processing unit 12 connects with the storage unit 11, the MAC 18, the memory unit 13 and the transmission interface 15 for controlling and processing data transmission. The power input unit 16 receives a voltage signal from a power supply (not shown) and provides the voltage to the multi-interface storage device 10 for the operation thereof so that the multi-interface storage device 10 can operate alone, and therefore, the multi-interface storage device 10 is able to communicate with the external electronic device 2 to transmit data stored in the storage unit 11 through the internet interface 14 and the MAC 18 when the computer system 1 is under power off status.

In the embodiment, the processing unit 12 could be but not limited to a micro-controller, the storage unit 11 could be but not limited to a solid state drive (SSD) or a hard disk drive (HDD), and the storage unit 11 could be a master hard disk or a slave hard disk, both of which can communicate with the external electronic device 2 through the internet interface 14 and the MAC 18 when the computer system 1 is under power off status, so that the external electronic device 2 can access data stored in the storage unit 11 through the internet interface 14.

As to some embodiments, the external electronic device 2 could be but not limited to a laptop, a Palm, a PDA, a PMP or a cellphone with camera. When the user goes out, he could connect the external electronic device 2 to the multi-interface storage device 10 and directly transmit and store data from the computer system 1 under the power off status of the computer system 1 without the complex procedures of turning on the computer system 1 remotely.

Moreover, the transmission interface 15 of the multi-interface storage device 10 could have many types, such as integrated device electronics interface (IDE interface), small computer system interface (SCSI), serial advanced technology attachment (SATA), universal serial bus (USB) or peripheral component interconnect express (PCI express), etc., but not limited thereto. The structures and the installing methods of the multi-interface storage device 10 vary in response to the different types of the transmission interface 15; for example, when the transmission interface 15 is a PCI express, the multi-interface storage device 10 will have a slot structure for inserting the PCI express thereinto.

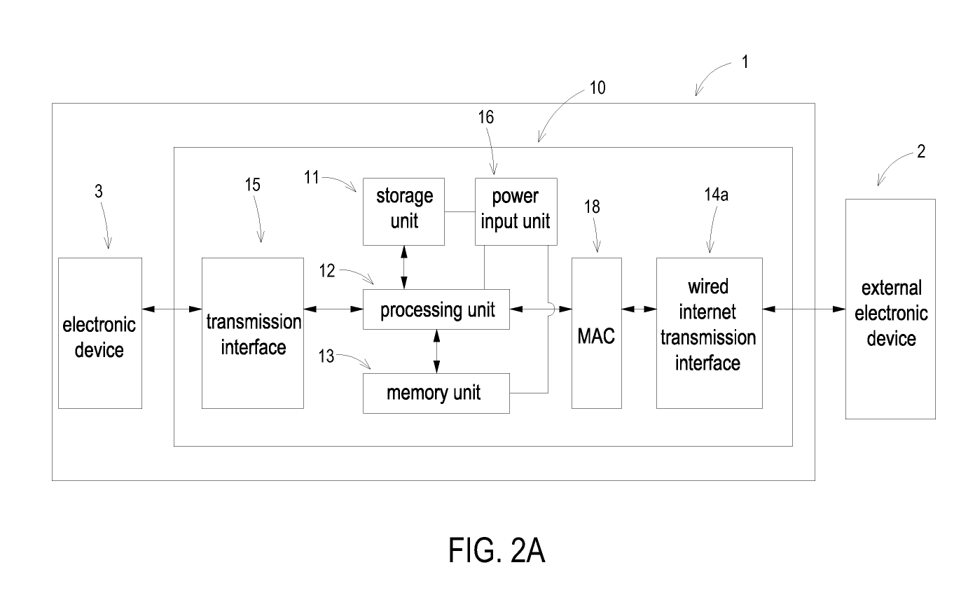

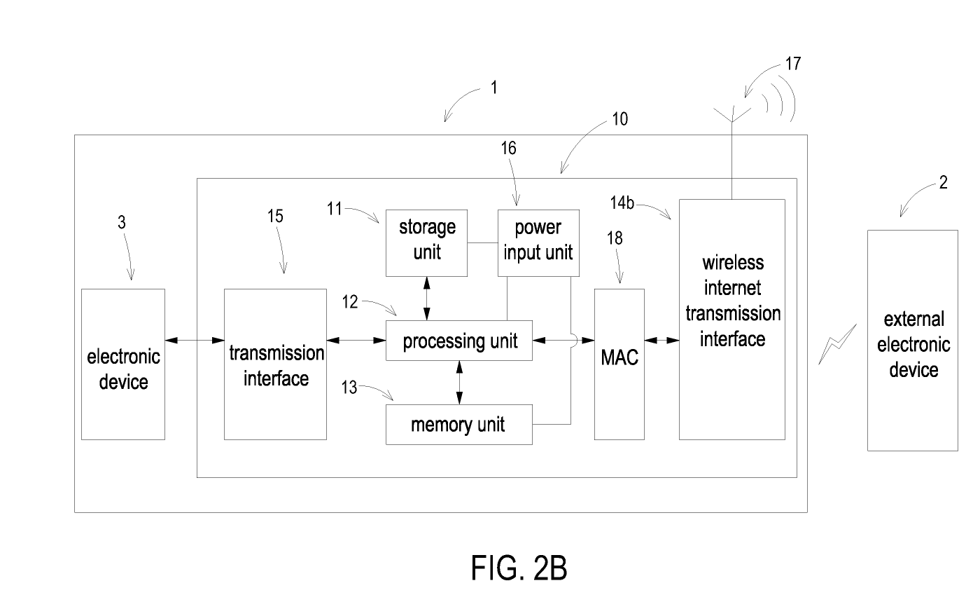

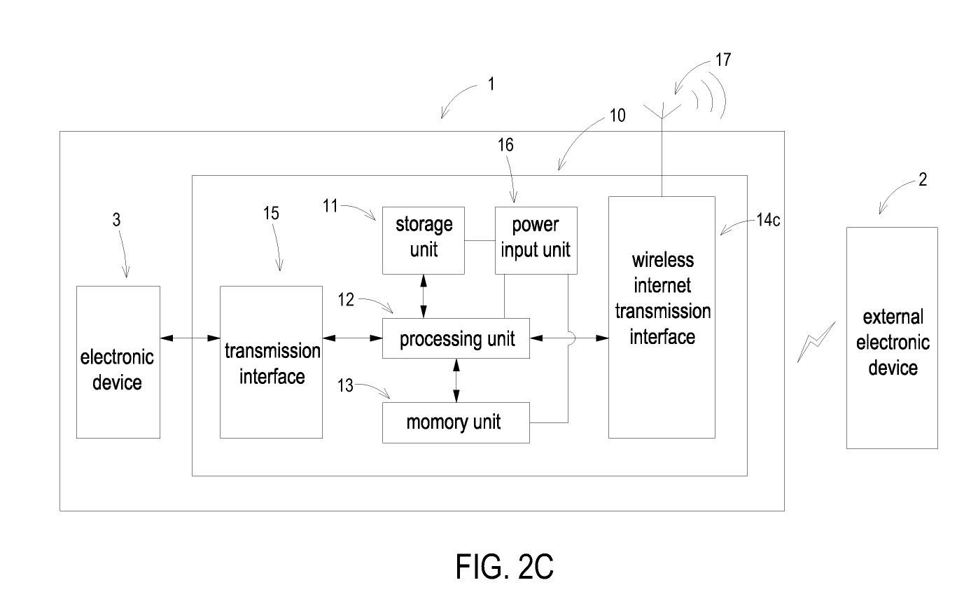

The types of the internet interface 14 of the multi-interface storage device 10 could be a wired internet transmission interface 14a or a wireless internet transmission interface 14b (as shown in FIGS. 2A and 2B). In some embodiments, when the multi-interface storage device 10 connects to the internet by using the wired internet transmission interface 14a, as shown in FIG. 2A, it will get an IP address through the MAC 18 and transmit data and communicate with the external electronic device 2 remotely. In other embodiments, as shown in FIG. 2B, when the multi-interface storage device 10 uses a wireless internet transmission interface 14b which needs an IP address to connect to the internet, the multi-interface storage device 10 connects to the external electronic device 2 through the MAC 18 to get an IP address, and the data stored in the storage unit 11 could be transmitted through the wireless internet transmission interface 14b and the antenna 17 to the external electronic device 2 to carry out the wireless communicating transmission such as wireless local area network (WLAN), worldwide interoperability for microwave access (Wi-Max) or wireless fidelity (Wi-Fi), etc.

While in some other embodiments, as shown in FIG. 2C, when the internet interface 14 of the multi-interface storage device 10 uses a wireless internet transmission interface 14c to connect to the internet which doesn't need an IP address, the data stored in the storage unit 11 could be transmitted through the wireless internet transmission interface 14c and the antenna 17 to the external electronic device 2 to carry out the wireless communicating transmission such as infrared data association (IrDA), blue tooth, general packet radio service (GPRS), global system for mobile (GSM), radio-frequency (RF), radio-frequency identification (RFID), etc.

Furthermore, in some embodiments, the multi-interface storage device 10 could have both the wired internet transmission interface 14a and the wireless internet transmission interface 14b to let the user choose to connect to the internet by using wired internet or wireless internet to transmit and to store data between the multi-interface storage device 10 and the external electronic device 2 under the power off status of the computer system 1.

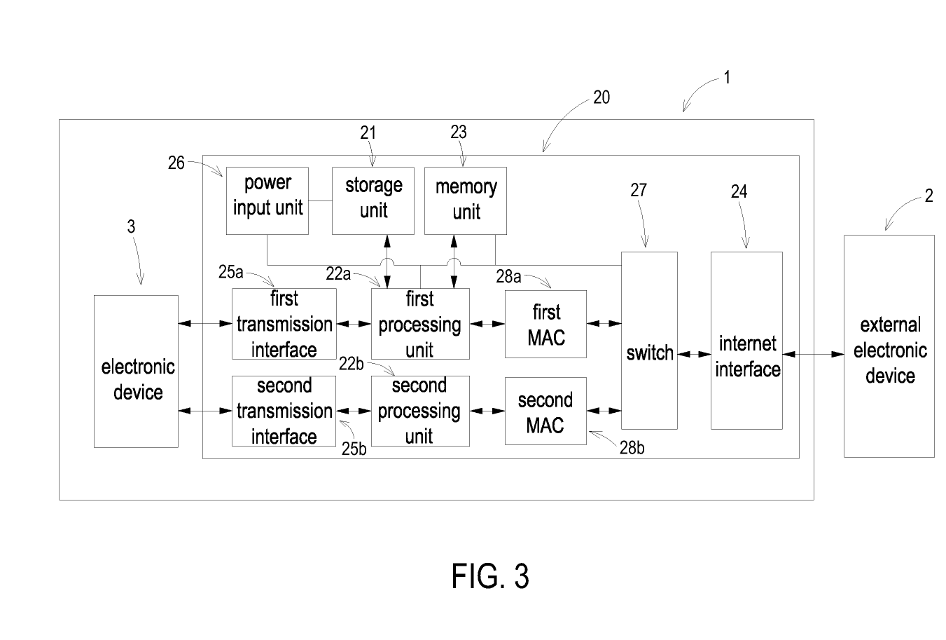

Please refer to FIG. 3, which is a schematic view of a multi-interface storage device according to another preferred embodiment of the present invention. As shown in FIG. 3, the multi-interface storage device 20 is disposed inside the computer 1, and includes a storage unit 21, a first processing unit 22a, a second processing unit 22b, a memory unit 23, an internet interface 24, a first transmission interface 25a, a second transmission interface 25b, a power input unit 26, a switch 27, a first MAC 28a and a second MAC 28b, wherein the first processing unit 22a and the second processing unit 22b could be but not limited to a micro-controller. The structures and the functions of the storage unit 21, the first processing unit 22a, the memory 23, the internet interface 24, the first transmission interface 25a and the power input 26 are the same as the previous embodiment, and are not redundantly described herein.

While in this embodiment, the multi-interface storage device 20 further comprises a second processing unit 22b, a second transmission interface 25b, a switch 27 and a second MAC 28b, and the multi-interface storage device 20 connects to the internet with the internet interface 24 through the switch 27 and the first MAC 28a so as to communicate with the external electronic device 2. Moreover, the electronic device 3 can connect to the internet through the second transmission interface 25b which could be but not limited to a PCI express, the second processing unit 22b, the second MAC 28b, the switch 27 and the internet interface 24, which means in this embodiment, the computer system 1 doesn't need another internet interface, since it can connect to the internet by using the internet interface 24 of the multi-interface storage device 20, which saves cost and increases operation convenience of the computer system 1.

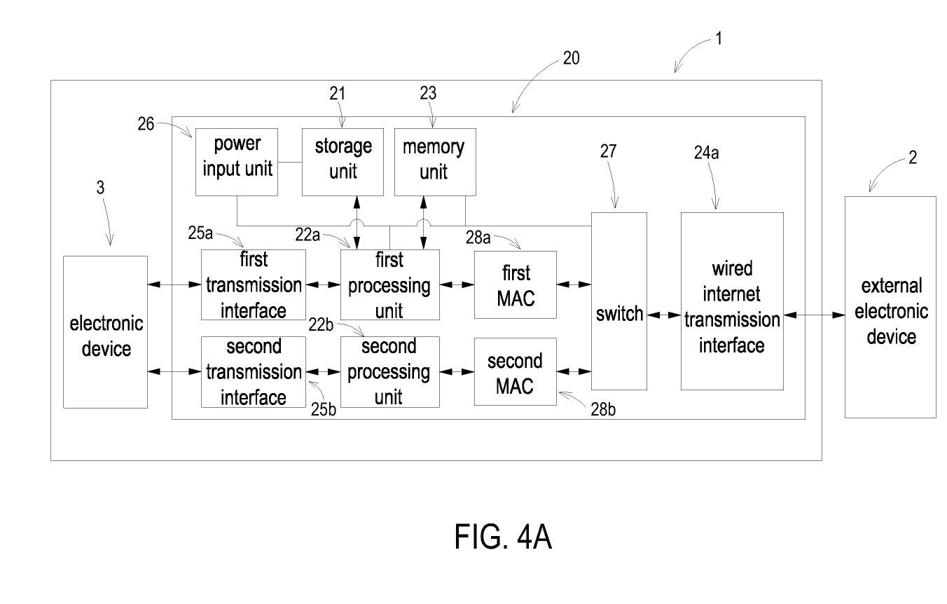

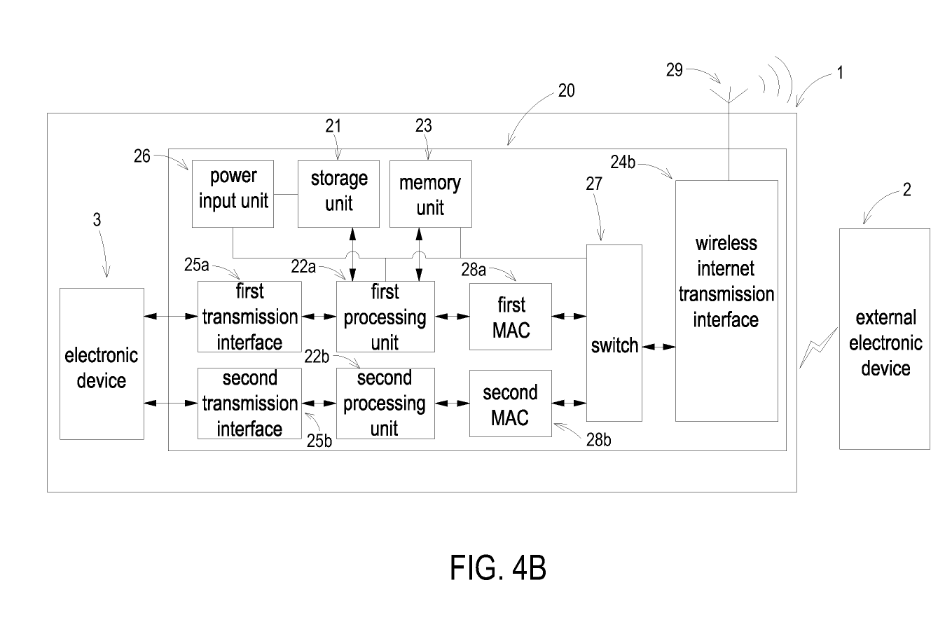

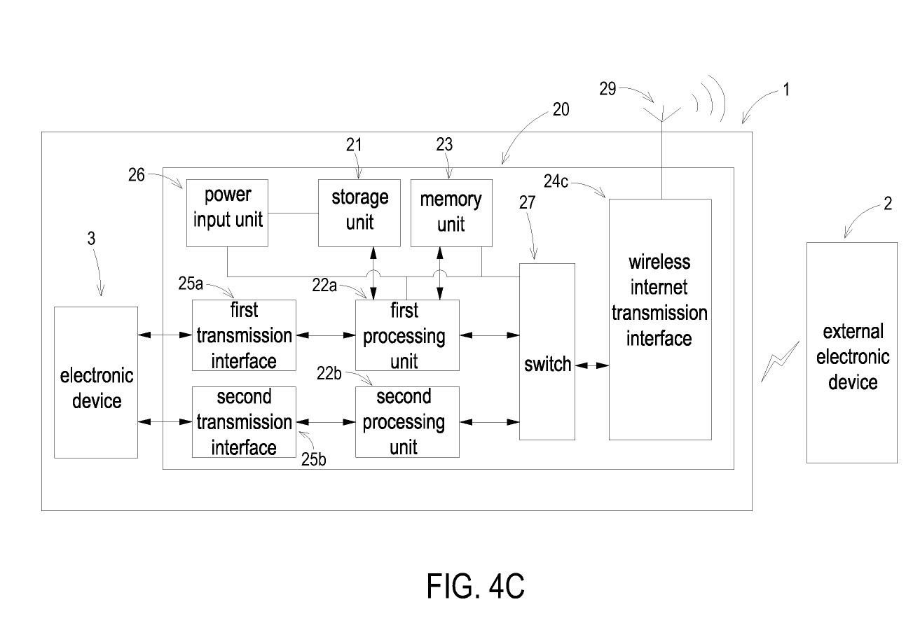

Please refer to FIGS. 4A and 4B, which are schematic views illustrating the multi-interface storage devices of FIG. 3 using different types of internet interfaces. As shown in FIG. 4A, when the internet interface 24 of the multi-interface storage device 20 is a wired internet transmission interface 24a, such as RJ45 interface, the electronic device 3 of the computer system 1 can connect to a wired internet through the second transmission interface 25b which could be but not limited to a PCI express, the second processing unit 22b, the second MAC 28b, the switch 27 and the wired internet transmission interface 24a, and the multi-interface storage device 20 can communicate with the external electronic device 2 through the first processing unit 22a, the first MAC 28a, the switch 27 and the wired internet transmission interface 24a under the power off status of the computer system 1.

On the contrary, when the internet interface 24 of the multi-interface storage device 20 is a wireless internet transmission interface 24b which needs an IP address to connect to the internet, as shown in FIG. 4B, both the electronic device 3 and the multi-interface storage device 20 of the computer system 1 can connect to a wireless internet such as WLAN, Wi-Max, Wi-Fi, etc. through the first MAC 28a, the second MAC 28b, the switch 27, the wireless internet transmission interface 24b and the antenna 29 so as to let the multi-interface storage device 20 communicate with the external electronic device 2 for data transmission under the power off status of the computer system 1.

Please refer to FIG. 4C, which is a schematic view illustrating the multi-interface storage device of FIG. 3 using another wireless internet transmission interface. The structures and the functions of the multi-interface storage device 20 have been already described in the previous embodiments, and what is different in this embodiment is the electronic device 3 of the computer system 1 connects to a wireless internet which doesn't need an IP address, such as IrDA, Blue tooth, GPRS, GSM, RF, RFID, etc., through the second transmission interface 25b which could be but not limited to a PCI express, the second processing unit 22b, the switch 27, the wireless internet transmission interface 24c and the antenna 29.

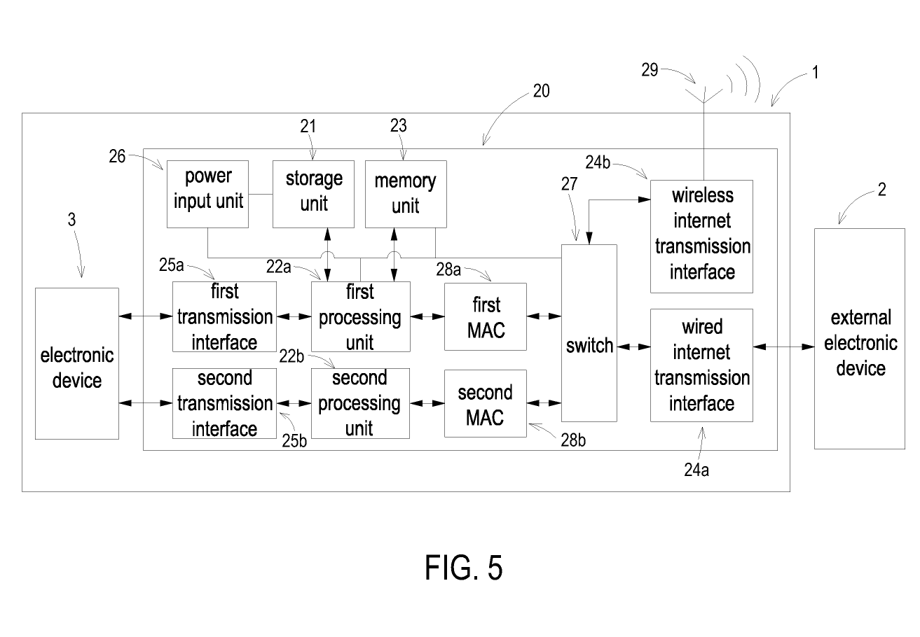

Please refer to FIG. 5, which is a schematic view illustrating the multi-interface storage device of FIG. 3 having both a wired internet transmission interface and a wireless internet transmission interface. As shown in FIG. 5, the structures and the functions of the storage unit 21, the first processing unit 22a, the second processing unit 22b, the memory unit 23, the first transmission interface 25a, the second transmission interface 25b, the first MAC 28a, the second MAC 28b, the power input unit 26 and the switch 27 of the multi-interface storage device 20 have been already described in previous embodiments, and what is different in this embodiment is that the multi-interface storage device 20 has both the wired internet transmission interface 24a and the wireless internet transmission interface 24b so that the electronic device 3 of the computer system 1 could choose to connect to a wired internet or a wireless internet by the second processing unit 22b, and the multi-interface storage device 20 could choose to communicate with the external electronic device 2 through a wired internet connection or a wireless internet connection by the first processing unit 22a. In such case, not only the multi-interface storage device 20 can communicate with the external electronic device 2 by a wired internet connection or a wireless internet connection under the power off status of the computer system 1 but also the electronic device 3 of the computer system 1 can connect to a wired internet or a wireless internet through the wired internet transmission interface 24a or the wireless internet transmission interface 24b when the computer system 1 is under the power on status, which has the advantages of saving cost and increasing operation convenience of the computer system 1.

In conclusion, the multi-interface storage device used in a computer system communicates with an external electronic device by an internet interface so as to let the external electronic device transmit and store data to and from the multi-interface storage device under the power off status of the computer system, and has advantages of saving the connection time and cost.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-interface storage device used in a computer under a power off status for transmitting data and communicating with an external electronic device remotely, comprising:
a transmission interface connected with an electronic device inside said computer;
an internet interface connected with said external electronic device;
a storage unit for storing data; and
a processing unit connected with said storage unit, said internet interface and said transmission interface for communicating with said external electronic device through said internet interface to enable said external electronic device to store and process said data stored in said storage unit under said power off status of said computer.

2. The multi-interface storage device according to claim 1 wherein said external electronic device is a laptop, a Palm, a PDA, a PMP or a cellphone with camera.

3. The multi-interface storage device according to claim 1 further comprising a power input unit for receiving a voltage signal for operation.

4. The multi-interface storage device according to claim 1 further comprising a memory unit for storing data needed for operation of said processing unit, wherein said memory unit is a ROM and/or a RAM.

5. The multi-interface storage device according to claim 1 further comprising a MAC connected with said internet interface and said processing unit for providing an IP address.

6. The multi-interface storage device according to claim 1 wherein said transmission interface is an IDE interface, an SCSI, an SATA interface, a USB or a PCI Express.

7. The multi-interface storage device according to claim 1 wherein said internet interface is a wired internet transmission interface being an IP interface.

8. The multi-interface storage device according to claim 1 wherein said internet interface is a wireless internet transmission interface being an IrDA interface, a Blue tooth interface, a GPRS interface, a GSM interface, a WLAN interface, a Wi-Max interface or a Wi-Fi interface.

9. The multi-interface storage device according to claim 1 wherein said storage unit is an SSD or an HDD.

10. The multi-interface storage device according to claim 1 wherein said processing unit is a micro-controller.

11. A multi-interface storage device used in a computer for transmitting data and communicating with an external electronic device remotely, comprising:
a first transmission interface connected with an electronic device inside said computer;
a second transmission interface connected with said electronic device inside said computer;
an internet interface connected with said external electronic device;
a storage unit for storing data;
a first processing unit connected with said storage unit and said first transmission interface;
a second processing unit connected with said second transmission interface; and
a switch connected with said first processing unit, said second processing unit and said internet interface, such that said first processing unit communicates with said external electronic device through said switch and said internet interface to enable said external electronic device to store and process said data stored in said storage unit under said power off status of said computer, and said second processing unit connects to an internet through said switch and said internet interface under a power on status of said computer.

12. The multi-interface storage device according to claim 11 wherein said external electronic device is a laptop, a Palm, a PDA, a PMP or a cellphone with camera.

13. The multi-interface storage device according to claim 11 further comprising a power input unit for receiving a voltage signal for operation.

14. The multi-interface storage device according to claim 11 further comprising a memory unit for storing data needed for operation of said processing unit, wherein said memory unit is a ROM and/or a RAM.

15. The multi-interface storage device according to claim 11 further comprising a first MAC connected with said switch and said first processing unit, and a second MAC connected with said switch and said second processing unit, wherein said first MAC and said second MAC are for providing an IP address.

16. The multi-interface storage device according to claim 11 wherein each of said first transmission interface and said second transmission is one of IDE interface, SCSI, SATA interface, USB and PCI Express.

17. The multi-interface storage device according to claim 11 wherein said internet interface is a wired internet transmission interface being an IP interface.

18. The multi-interface storage device according to claim 11 wherein said internet interface is a wireless internet transmission interface being an IrDA interface, a Blue tooth interface, a GPRS interface, a GSM interface, a WLAN interface, a Wi-Max interface or a Wi-Fi interface.

19. The multi-interface storage device according to claim 11 wherein said storage unit is an SSD or an HDD.

20. The multi-interface storage device according to claim 11 wherein said processing unit is a micro-controller.
